(19) United States
(12) Patent Application Publication
(10) Pub. No.: US 2009/0111347 A1
(43) Pub. Date: Apr. 30, 2009

(54) SOFT AND EXTENSIBLE POLYPROPYLENE BASED SPUNBOND NONWOVENS

(76) Inventors: Hong Peng, Lake Jackson, TX (US); Gert J. Claasen, Adliswil (CH); Jozef J. Van Dun, Zandhoven (BE); Thomas T. Allgeuer, Wollerau (CH)

Correspondence Address: The Dow Chemical Company, Intellectual Property Section, P.O. Box 1967, Midland, MI, 48641-1967, US

(21) Appl. No.: 12/301,509

(22) PCT Filed: May 21, 2007
(86) PCT No.: PCT/US07/69374

§ 371 Date: Nov. 19, 2008

Related U.S. Application Data
(60) Provisional application No. 60/808,349, filed on May 25, 2006.

(51) Int. Cl. D04H 5/00; B29C 47/00

(52) U.S. Cl. 442/334; 264/211

(57) ABSTRACT

The present invention relates to nonwoven webs or fabrics. In particular, the present invention relates to nonwoven webs having superior abrasion resistance and excellent softness characteristics. The nonwoven materials comprise fibers made from of a polymer blend of isotactic polypropylene and reactor grade propylene based elastomers or plastomers together with from about 100 to about 2500 ppm (by weight of the fiber) of a slip agent. The isotactic polypropylene can be homopolymer polypropylene, and/or random copolymers of propylene and one or more alpha-olefins. The reactor grade propylene based elastomers or plastomers have a molecular weight distribution of less than about 3.5, and a heat of fusion less than about 90 joules/gm. In particular, the reactor grade propylene based elastomers or plastomers contains from about 3 to about 15 percent by weight of units derived from an ethylene and a melt flow rate of from about 2 to about 200 grams/10 minutes. Erucamide is the preferred slip additive.

### CROSS REFERENCE STATEMENT

This application claims the benefit of U.S. Provisional Application No. 60/808,349, filed May 25, 2006.

### FIELD OF THE INVENTION

The present invention relates to nonwoven webs or fabrics. In particular, the present invention relates to nonwoven webs having good drapeability, superior abrasion resistance and excellent softness characteristics. The nonwoven materials comprise fibers made from of a polymer blend of isotactic polypropylene, reactor grade propylene based elastomers or plastomers, and a slip additive.

### BACKGROUND AND SUMMARY OF THE INVENTION

Nonwoven webs or fabrics are desirable for use in a variety of products such as bandaging materials, garments, disposable diapers, and other personal hygiene products, including pre-moistened wipes. Nonwoven webs having high levels of strength, softness, and abrasion resistance are desirable for disposable absorbent garments, such as diapers, incontinence briefs, training pants, feminine hygiene products, and the like. For example, in a disposable diaper, it is highly desirable to have soft, strong, nonwoven components, such as topsheets or backsheets (also known as outer covers). Topsheets form the inner, body-contacting portion of a diaper which makes softness highly beneficial. Backsheets benefit from the appearance of being cloth-like, and softness adds to the cloth-like perception consumers prefer. Abrasion resistance relates to a nonwoven web's durability, and is characterized by a lack of significant loss of fibers in use.

Abrasion resistance can be characterized by a nonwoven's tendency to “fuzz” which may also be described as “linting” or “pilling”. Fuzzing occurs as fibers, or small bundles of fibers, are rubbed off, pulled, off, or otherwise released from the surface of the nonwoven web. Fuzzing can result in fibers remaining on the skin or clothing of the wearer or others, as well as a loss of integrity in the nonwoven, both highly undesirable conditions for users.

Fuzzing can be controlled in much the same way that strength is imparted, that is, by bonding or entangling adjacent fibers in the nonwoven web to one another. To the extent that fibers of the nonwoven web are bonded to, or entangled with, one another, strength can be increased, and fuzzing levels can be controlled.

Softness can be improved by mechanically post treating a nonwoven. For example, by incrementally stretching a nonwoven web by the method disclosed in U.S. Pat. No. 5,626,571, issued May 6, 1997 in the names of Young et al., the nonwoven web can be made soft and extensible, while retaining sufficient strength for use in disposable absorbent articles. Young et al., which is hereby incorporated herein by reference, teaches making a nonwoven web which is soft and strong by permanently stretching an inelastic base nonwoven in the cross-machine direction. However, it is believed that such mechanical methods would negatively effect the fuzz levels (or decrease the abrasion resistance) observed in such nonwoven webs.

One method of bonding, or “consolidating”, a nonwoven web is to bond adjacent fibers in a regular pattern of spaced, thermal spot bonds. One suitable method of thermal bonding is described in U.S. Pat. No. 3,855,046, issued Dec. 17, 1974 to Hansen et al., which is hereby incorporated herein by reference. Hansen et al. teach a thermal bond pattern having a 10-25 percent bond area (termed “consolidation area” herein) to render the surfaces of the nonwoven web abrasion resistant. However, even greater abrasion resistance together with increased softness can further benefit the use of nonwoven webs in many applications, including disposable absorbent articles, such as diapers, training pants, feminine hygiene articles, and the like.

By increasing the size of the bond sites; or by decreasing the distance between bond sites, more fibers are bonded, and abrasion resistance can be increased, (fuzzing can be reduced). However, the corresponding increase in bond area of the nonwoven also increases the bending rigidity (that is, stiffness), which is inversely related to a perception of softness (that is, as bending rigidity increases, softness decreases). In other words, abrasion resistance is directly proportional to bending rigidity when achieved by these known methods. Because abrasion resistance correlates to fuzzing, and bending resistance correlates to perceived softness, known methods of nonwoven production require a tradeoff between the fuzzing and softness properties of a nonwoven.

Various approaches have been tried to improve the abrasion resistance of nonwoven materials without compromising softness. For example, U.S. Pat. Nos. 5,405,682 and 5,425,987, both issued to Shawyer et al., teach a soft, yet durable, cloth-like nonwoven fabric made with multicomponent polymeric strands. However, the multicomponent fibers disclosed comprise a relatively expensive elastomeric thermoplastic material (that is KRATON™) in one side or the sheath of multicomponent polymeric strands. U.S. Pat. No. 5,336,552 issued to Strack et al., discloses a similar approach in which an ethylene alkyl acrylate copolymer is used as an abrasion resistance additive in multicomponent polyolefin fibers. U.S. Pat. No. 5,545,464, issued to Stokes describes a pattern bonded nonwoven fabric of conjugate fibers in which a lower melting point polymer is enveloped by a higher melting point polymer.

Bond patterns have also been utilized to improve strength and abrasion resistance in nonwovens while maintaining or even improving softness. Various bond patterns have been developed to achieve improved abrasion resistance without too negatively affecting softness. U.S. Pat. No. 5,964,742 issued to McCormack et al., discloses a thermal bonding pattern comprising elements having a predetermined aspect ratio. The specified bond shapes reportedly provide sufficient numbers of immobilized fibers to strengthen the fabric, yet not so much as to increase stiffness unacceptably. U.S. Pat. No. 6,015,605 issued to TsuJiyama et al., discloses very specific thermally press bonded portions in order to deliver strength, hand feeling, and abrasion resistance. However, with all bond pattern solutions it is believed that the essential tradeoff between bond area and softness remains.

Another approach for improving the abrasion resistance of nonwoven materials without compromising softness is to optimize the polymer content of the fibers used to make the nonwoven materials. A variety of fibers and fabrics have been made from thermoplastics, such as polypropylene, highly branched low density polyethylene (LDPE) made typically in a high pressure polymerization process, linear heterogeneously branched polyethylene (for example, linear low density polyethylene made using Ziegler catalysis), blends of polypropylene and linear heterogeneously branched polyethylene, blends of linear heterogeneously branched polyethylene, and ethylene/vinyl alcohol copolymers.

Of the various polymers known to be extrudable into fiber, highly branched LDPE has not been successfully melt spun into fine denier fiber. Linear heterogeneously branched polyethylene has been made into monofilament, as described in U.S. Pat. No. 4,076,698 (Anderson et al.), the disclosure of which is incorporated herein by reference. Linear heterogeneously branched polyethylene has also been successfully made into fine denier fiber, as disclosed in U.S. Pat. No. 4,644,045 (Fowells), U.S. Pat. No. 4,830,907 (Sawyer et al.), U.S. Pat. No. 4,909,975 (Sawyer et al.) and in U.S. Pat. No. 4,578,414 (Sawyer et al.), the disclosures of which are incorporated herein by reference. Blends of such heterogeneously branched polyethylene have also been successfully made into fine denier fiber and fabrics, as disclosed in U.S. Pat. No. 4,842,922 (Krupp et al.), U.S. Pat. No. 4,990,204 (Krupp et al.) and U.S. Pat. No. 5,112,686 (Krupp et al.), the disclosures of which are all incorporated herein by reference. U.S. Pat. No. 5,068,141 (Kubo et al.) also discloses making nonwoven fabrics from continuous heat bonded filaments of certain heterogeneously branched LLDPE having specified heats of fusion. While the use of blends of heterogeneously branched polymers produces improved fabric, the polymers are more difficult to spin without fiber breaks.

U.S. Pat. No. 5,549,867 (Gessner et al.), describes the addition of a low molecular weight polyolefin to a polyolefin with a molecular weight (Mz) of from 400,000 to 580,000 to improve spinning. The Examples set forth in Gessner et al. are directed to blends of 10 to 30 weight percent of a lower molecular weight metallocene polypropylene with from 70 to 90 weight percent of a higher molecular weight polypropylene produced using a Ziegler-Natta catalyst.

WO 95/32091 (Stahl et al.) discloses a reduction in bonding temperatures by utilizing blends of fibers produced from polypropylene resins having different melting points and produced by different fiber manufacturing processes, for example, meltblown and spunbond fibers. Stahl et al. claims a fiber comprising a blend of an isotactic propylene copolymer with a higher melting thermoplastic polymer. However, while Stahl et al. provides some teaching as to the manipulation of bond temperature by using blends of different fibers, Stahl et al. does not provide guidance as to means for improving fabric strength of fabric made from fibers having the same melting point.

U.S. Pat. No. 5,677,383, in the names of Lai, Knight, Chum, and Markovich, incorporated herein by reference, discloses blends of substantially linear ethylene polymers with heterogeneously branched ethylene polymers, and the use of such blends in a variety of end use applications, including fibers. The disclosed compositions preferably comprise a substantially linear ethylene polymer having a density of at least 0.89 grams/centimeters³. However, Lai et al. disclosed bonding temperatures only above 165° C. In contrast, to preserve fiber integrity, fabrics are frequently bonded at lower temperatures, such that all of the crystalline material is not melted before or during fusion.

European Patent Publication (EP) 340,982 discloses bicomponent fibers comprising a first component core and a second component sheath, which second component further comprises a blend of an amorphous polymer with an at least partially crystalline polymer. The disclosed range of the amorphous polymer to the crystalline polymer is from 15:85 to 00-[sic, 90]:10. Preferably, the second component will comprise crystalline and amorphous polymers of the same general polymeric type as the first component, with polyester being preferred. For instance, the examples disclose the use of an amorphous and a crystalline polyester as the second component. EP 340,982, at Tables I and II, indicates that as the melt index of the amorphous polymer decreases, the web strength likewise detrimentally decreases. Incumbent polymer compositions include linear low density polyethylene and high density polyethylene having a melt index generally in the range of 0.7 to 200 grams/10 minutes.

U.S. Pat. Nos. 6,015,617 and 6,270,891 teach the inclusion of a low melting point homogeneous polymer to a higher melting point polymer having an optimum melt index can usefully provide a calendered fabric having an improved bond performance, while maintaining adequate fiber spinning performance.

U.S. Pat. No. 5,804,286 teaches that the bonding of LLDPE filaments into a spunbond web with acceptable abrasion resistance is difficult since the temperature at which acceptable tie down is observed is nearly the same as the temperature at which the filaments melt and stick to the calendar. This reference concludes that this explains why spunbonded LLDPE nonwovens have not found wide commercial acceptance.

WO 2005/111282 teaches nonwoven fabrics made from fibers comprising blends of isotactic polypropylene with a reactor grade propylene based plastomer or elastomer. While these materials demonstrate an improvement of the existing commercial materials, it is desired to have even better softness without sacrificing the physical properties such as tenacity and abrasion resistance.

While such polymers have found good success in the marketplace in fiber applications, the fibers made from such polymers would benefit from an improvement in flexibility and bond strength, which would lead to soft abrasion-resistant fabrics, and accordingly to increased value to the nonwoven fabric and article manufacturers, as well as to the ultimate consumer. However, any benefit in softness, bond strength and abrasion resistance must not be at the cost of a detrimental reduction in spinnability or a detrimental increase in the sticking of the fibers or fabric to equipment during processing.

US 2003/0157859 teaches polyolefin based non-woven fabric characterized by containing a fatty acid amide compound, and by having a static friction coefficient in the range of 0.1 to 0.4. This reference teaches that use of levels of the fatty acid amide compound up to 1 percent will provide fabrics with good hand and touch feeling. The inventors of the present invention have found that such levels lead to die build up which hurts the spinnability of such materials in a spunbond process, as well as resulting in fabrics having an oily feel which is considered detrimental in many parts of the world. It is desirable to have good hand and touch feeling without harming the spinnablity of the fiber or resulting in an overly oily feeling.

Accordingly, there is a continuing unaddressed need for a nonwoven with greater softness and elongation while maintaining spinnability and abrasion resistance.

Additionally, there is a continuing unaddressed need for a low fuzzing, soft nonwoven suitable for use as a component in a disposable absorbent article.

Additionally, there is a continuing unaddressed need for a soft, extensible nonwoven web having relatively high abrasion resistance.

Further, there is a continuing unaddressed need for a method of processing a nonwoven such that abrasion resistance is achieved with little or no decrease in softness.

There is also a need for fibers, particularly spunbond fibers which have a broader bonding window, increased bonding strength and abrasion resistance, improved softness and good spinnability.

In one aspect, the present invention is a spun bond nonwoven fabric made using fibers having a diameter in a range of from 0.1 to 50 denier and wherein the fibers comprise:

a. from about 50 to about 90 percent (by weight of the fiber) of a first polymer which is an isotactic polypropylene homopolymer or random copolymer having a melt flow rate in the range of from about 10 to about 70 grams/10 minutes, and

b. from about 10 to about 50 percent (by weight of the fiber) of a second polymer which is a reactor grade propylene based elastomer or plastomer having a heat of fusion less than about 70 joules/gm, said propylene based elastomer or plastomer having a melt flow rate of from about 2 to about 1000 grams/10 minutes, and

c. from about 100 to about 2500 ppm (by weight of the fiber) of a slip agent.

When ethylene is used as a comonomer in the reactor grade propylene based elastomer or plastomer, the material will have from about 5 to about 20 percent (by weight of Component b) of ethylene.

In another aspect, the present invention is a melt blown nonwoven fabric made using fibers having a diameter in a range of from 0.1 to 50 denier and fibers comprises a polymer blend, wherein the polymer blend comprises:

a. from about 50 to about 90 percent (by weight of the polymer blend) of a first polymer which is an isotactic polypropylene homopolymer or random copolymer having a melt flow rate in the range of from about 100 to about 2000 grams/10 minutes, and

b. from about 10 to about 50 percent (by weight of the polymer blend) of a second polymer which is a reactor grade propylene based elastomer or plastomer having a heat of fusion less than about 70 joules/gm, said propylene based elastomer or plastomer having a melt flow rate of from about 100 to about 2000 grams/10 minutes, and

c. from about 100 to about 2500 ppm of a slip agent.

When ethylene is used as a comonomer in the reactor grade propylene based elastomer or plastomer, the material will have from about 5 to about 20 percent (by weight of Component b) of ethylene.

In another aspect, the present invention is a fiber, wherein the fiber has a denier greater than about 7 and wherein the fiber comprises a polymer blend comprising:
a. from about 50 to about 90 percent by weight of the polymer blend, of a first polymer which is an isotactic polypropylene having a melt flow rate in the range of from about 2 to about 40 grams/10 minutes,
b. from about 10 to about 50 percent by weight of the polymer blend of a second polymer which is a reactor grade propylene based elastomer or plastomer having a molecular weight distribution of less than about 3.5, wherein said second polymer has heat of fusion of less than about 90 joules/gm and wherein said second polymer has a melt flow rate of from about 0.5 to about 40 grams/10 minutes, and
c. from about 100 to about 2500 ppm of a slip agent and

wherein the polymer blend contains less than about 5 percent by weight of units derived from ethylene.

When ethylene is used as a comonomer in the reactor grade propylene based elastomer or plastomer, the material will have from about 5 to about 20 percent (by weight of Component b) of ethylene.

In another aspect, the present invention provides a nonwoven material having a Fuzz/Abrasion of less than 0.5 mg/cm², and a flexural rigidity of less than or equal to 0.043*Basis Weight−0.657 mN.cm. The nonwoven material in this aspect will preferably have a basis weight greater than 10 grams/m², a tensile strength of more than 25 N/5 cm in MD (at a basis weight of 20 GSM), and a consolidation area of less than 25 percent.

Another aspect of the present invention is a finished article made from the nonwoven materials of the present invention.

### DETAILED DESCRIPTION OF THE INVENTION

As used herein, the term “nonwoven web”, refers to a web that has a structure of individual fibers or threads which are interlaid, but not in any regular, repeating manner. Nonwoven webs have been, in the past, formed by a variety of processes, such as, for example, air laying processes, meltblowing processes, spunbonding processes and carding processes, including bonded carded web processes.

As used herein, the term “microfibers”, refers to small diameter fibers having an average diameter not greater than about 100 microns. Fibers, and in particular, spunbond fibers utilized in the present invention can be microfibers, or more specifically, they can be fibers having an average diameter of about 15-30 microns, and having a denier from about 1.5-3.0.

As used herein, the term “meltblown fibers”, refers to fibers formed by extruding a molten thermoplastic material through a plurality of fine, usually circular, die capillaries as molten threads or filaments into a high velocity gas (for example, air) stream which attenuates the filaments of molten thermoplastic material to reduce their diameter, which may be to a microfiber diameter. Thereafter, the meltblown fibers are carried by the high velocity gas stream and are deposited on a collecting surface to form a web of randomly dispersed meltblown fibers.

As used herein, the term “spunbonded fibers”, refers to small diameter fibers which are formed by extruding a molten thermoplastic material as filaments from a plurality of fine, usually circular, capillaries of a spinneret with the diameter of the extruded filaments then being rapidly reduced by drawing.

As used herein, the terms “consolidation” and “consolidated” refer to the bringing together of at least a portion of the fibers of a nonwoven web into closer proximity to form a site, or sites, which function to increase the resistance of the nonwoven to external forces, for example, abrasion and tensile forces, as compared to the unconsolidated web. “Consolidated” can refer to an entire nonwoven web that has been processed such that at least a portion of the fibers are brought into closer proximity, such as by thermal point bonding. Such a web can be considered a “consolidated web”. In another sense, a specific, discrete region of fibers that is brought into close proximity, such as an individual thermal bond site, can be described as “consolidated”.

Consolidation can be achieved by methods that apply heat and/or pressure to the fibrous web, such as thermal spot (that is, point) bonding. Thermal point bonding can be accomplished by passing the fibrous web through a pressure nip formed by two rolls, one of which is heated and contains a plurality of raised points on its surface, as is described in the aforementioned U.S. Pat. No. 3,855,046 issued to Hansen et al. Consolidation methods can also include ultrasonic bonding, through-air bonding, and hydroentanglement. Hydroentanglement typically involves treatment of the fibrous web with high pressure water jets to consolidate the web via mechanical fiber entanglement (friction) in the region desired to be consolidated, with the sites being formed in the area of fiber entanglement. The fibers can be hydroentangled as taught in U.S. Pat. Nos. 4,021,284 issued to Kalwaites on May 3, 1977 and 4,024,612 issued to Contrator et al. on May 24, 1977, both of which are hereby incorporated herein by reference. In the currently preferred embodiment, the polymeric fibers of the nonwoven are consolidated by point bonds, sometimes referred to as “partial consolidation” because of the plurality of discrete, spaced-apart bond sites.

As used herein, the term “polymer” generally includes, but is not limited to, homopolymers, copolymers, such as, for example, block, graft, random and alternating copolymers, terpolymers, etc., and blends and modifications thereof. Furthermore, unless otherwise specifically limited, the term “polymer” shall include all possible geometrical configurations of the material. These configurations include, but are not limited to, isotactic, syndiotactic and random symmetries.

As used herein, the term “polypropylene plastomers” includes reactor grade copolymers of propylene having heat of fusion between about 100 joules/gm to about 40 joules/gm and MWD<3.5. An example of propylene plastomers include reactor grade propylene-ethylene copolymer having weight percent ethylene in the range of about 3 wt percent to about 10 wt percent, having MWD<3.5.

As used herein, the term “polypropylene elastomers” includes reactor grade copolymers of propylene having heat of fusion less than about 40 joules/gm and MWD<3.5. An example of propylene elastomers include reactor grade propylene-ethylene copolymer having weight percent ethylene in the range of about 10 wt percent to about 15 wt percent, having MWD<3.5.

As used herein, the term “extensible” refers to any material which, upon application of a biasing force, is elongatable, to at least about 50 percent more preferably at least about 70 percent without experiencing catastrophic failure.

All percentages specified herein are weight percentages unless otherwise specified.

As used herein a “nonwoven” or “nonwoven fabric” or “nonwoven material” means an assembly of fibers held together in a random web such as by mechanical interlocking or by fusing at least a portion of the fibers. Nonwoven fabrics can be made by various methods, including spunlaced (or hydrodynamically entangled) fabrics as disclosed in U.S. Pat. No. 3,485,706 (Evans) and U.S. Pat. No. 4,939,016 (Radwanski et al.), the disclosures of which are incorporated herein by reference; by carding and thermally bonding staple fibers; by spunbonding continuous fibers in one continuous operation; or by melt blowing fibers into fabric and subsequently calendering or thermally bonding the resultant web. These various nonwoven fabric manufacturing techniques are well known to those skilled in the art. The fibers of the present invention are particularly well suited to make a spunbonded nonwoven material.

Lubricants used with resins are generally classified as either an internal lubricant or an external lubricant. While internal lubricants are generally used for improving the production and shaping the plastic melt, or influencing the rheological behaviors, the external lubricants are used for imparting good slip properties on finished part surface. The difference between the internal and external lubricants is their solubility in the resin, as is generally known in the art (see, for example, I. Quijada-Garrido, M. Wilhelm, H. W. Spiess and J. M. Barrales-Rienda, “Solid-State NMR Studies of Structure and Dynamics of Erucamide/Isotactic Poly(Propylene) Blends”, Macromol. Chem. Phys., vol 199, pg. 985-995 (1998)). Internal lubricant normally is considered as compatible and soluble in the resin, but external lubricant is defined as incompatible and generally insoluble in the resin. The effect of the external lubricants is generally believed to be explained in terms of a release film being formed between the melt and metal surface. For nonpolar polyolefin resins, hydrocarbon waxes, for example, are readily soluble in polyethylene while polar esters are incompatible and hence would be considered as external lubricants. (see R. Gachter and H. Muller, “Plastic Additives Handbook—Stabilizers, Processing Aids, Plasticizers, Fillers, Reinforcements, Colorants for Thermoplastics”, 3rd Edition, Hanser Publishers, New York, 1990, p 426-429).

As used herein “slip additive” or “slip agent” means an external lubricant. The slip agent when melt-blended with the resin gradually exudes or migrates to the surface during cooling or after fabrication, hence forming a uniform, invisibly thin coating thereby yielding permanent lubricating effects.

A primary aspect of the present invention is a spun bond nonwoven fabric made using fibers having a diameter in a range of from 0.1 to 50 denier wherein the fibers comprise:

a. from about 50 to about 90 percent (by weight of the fiber) of a first polymer which is an isotactic polypropylene homopolymer or random copolymer having a melt flow rate in the range of from about 10 to about 70 grams/10 minutes, and

b. from about 10 to about 50 percent (by weight of the fiber) of a second polymer which is a reactor grade propylene based elastomer or plastomer having a heat of fusion less than about 70 joules/gm, said propylene based elastomer or plastomer having a melt flow rate of from about 2 to about 1000 grams/10 minutes, and

c. from about 100 to about 2500 ppm of a slip agent.

It is preferred that the components a and b together comprise less than 5 weight percent ethylene by weight.

The first component of the fiber is an isotactic polypropylene homopolymer or random copolymer polypropylene having a melt flow rate (MFR) in the range of from about 10 to about 70 grams/10 minutes as determined by ASTM D-1238, condition 230° C./2.16 kg (formerly known as “Condition L”).

The first polymer of the polymer blend is isotactic polypropylene homopolymer or random copolymer having a melt flow rate (MFR) in the range of from about 10 to about 2000 grams/10 minutes, preferably about 15 to 200 grams/10 minutes, more preferably about 25 to 40 grams/10 minutes as determined by ASTM D-1238, Condition 230° C./2.16 kg (formerly known as “Condition L”). Suitable examples of material which can be selected for the first polymer include homopolymer polypropylene and random copolymers of propylene and α-olefins.

Homopolymer polypropylene suitable for use as the first polymer can be made in any way known to the art. Random copolymers of propylene and α-olefins, made in any way known to the art, can also be used as all or part of the first polymer of the present invention. Ethylene is the preferred α-olefin. The co-monomer content in the first polymer must be such that the first polymer has a heat of fusion more than 90 joules/gm, preferably more than 100 joules/gm and is therefore generally less than about three percent by weight of the copolymer of ethylene, preferably less than one percent by weight of ethylene. The heat of fusion is determined using differential scanning calorimetry (DSC) using a method similar to ASTM D3417-97, as described below.

The polymer sample having 5-10 mg weight is rapidly heated (about 100° C. per minute) in the DSC to 230° C. and kept there for three minutes to erase all thermal history. The sample is cooled to −60° C. at 10° C./min cooling rate and kept there for three minutes. The sample is then heated at 10° C./min to 230° C. (second melting). The heat of fusion is determined using the software to integrate the area under the second melting curve using linear baseline. Note that the DSC needs to be well calibrated, using methods known in the art to obtain straight baselines, quantitative heats of fusion and accurate melting/crystallization temperatures.

The second polymer of the polymer blend is a reactor grade propylene based elastomer or plastomer having MWD<3.5, and having heat of fusion less than about 90 joules/gm, preferably less than about 70 joules/gm, more preferably less than about 50 joules/gm. When ethylene is used as a comonomer, the reactor grade propylene based elastomer or plastomer has from about 3 to about 15 percent (by weight of Component b) of ethylene, preferably from about 5 to about 14 percent of ethylene, more preferably about 9 to 12 percent ethylene, by weight of the propylene based elastomer or plastomer. Suitable propylene based elastomers and/or plastomers are taught in WO03/040442, which is hereby incorporated by reference in its entirety.

It is intended that the term “reactor grade” is as defined in U.S. Pat. No. 6,010,588 and in general refers to a polyolefin resin whose molecular weight distribution (MWD) or polydispersity has not been substantially altered after polymerization.

Although the remaining units of the propylene copolymer are derived from at least one comonomer such as ethylene, a C₄₋₂₀ alpha-olefin, a C₄₋₂₀ diene, a styrenic compound and the like, preferably the comonomer is at least one of ethylene and a C₄₋₁₂ alpha-olefin such as 1-hexene or 1-octene. Preferably, the remaining units of the copolymer are derived only from ethylene.

The amount of comonomer other than ethylene in the propylene based elastomer or plastomer is a function of, at least in part, the comonomer and the desired heat of fusion of the copolymer. If the comonomer is ethylene, then typically the comonomer-derived units comprise not in excess of about 15 wt percent of the copolymer. The minimum amount of ethylene-derived units is typically at least about 3, preferable at least about 5 and more preferably at least about 9, wt percent based upon the weight of the copolymer.

The propylene based elastomer or plastomer of this invention can be made by any process, and includes copolymers made by Zeigler-Natta, CGC (Constrained Geometry Catalyst), metallocene, and nonmetallocene, metal-centered, heteroaryl ligand catalysis. These copolymers include random, block and graft copolymers although preferably the copolymers are of a random configuration. Exemplary propylene copolymers include Exxon-Mobil VISTAMAXX polymer, and propylene/ethylene copolymers by The Dow Chemical Company.

The density of the propylene based elastomers or plastomers of this invention is typically at least about 0.850, can be at least about 0.860 and can also be at least about 0.865 grams per cubic centimeter (g/cm³).

The weight average molecular weight (Mw) of the propylene based elastomers or plastomers of this invention can vary widely, but typically it is between about 10,000 and 1,000,000 (with the understanding that the only limit on the minimum or the maximum M_{w} is that set by practical considerations). For homopolymers and copolymers used in the manufacture of meltblown fabrics, preferably the minimum Mw is about 20,000, more preferably about 25,000.

The propylene based elastomers or plastomers of this invention typically have an MFR of at least about 1, can be at least about 5, can also be at least about 10 can also be at least about 15 and can also be at least about 25. The maximum MFR typically does not exceed about 2,000, preferably it does not exceed about 1000, more preferably it does not exceed about 500, still more preferably it does not exceed about 200 and most preferably it does not exceed about 70. MFR for copolymers of propylene and ethylene and/or one or more C₄-C₂₀ α-olefins is measured according to ASTM D-1238, condition L (2.16 kg, 230 degrees C.).

The polydispersity of the propylene based elastomers or plastomers of this invention is typically between about 2 and about 3.5. “Narrow polydisperity”, “narrow molecular weight distribution”, “narrow MWD” and similar terms mean a ratio (M_{w}/Mₙ) of weight average molecular weight (M_{w}) to number average molecular weight (Me) of less than about 3.5, can be less than about 3.0, can also be less than about 2.8, can also be less than about 2.5, and can also be less than about 2.3. Polymers for use in fiber applications typically have a narrow polydispersity. Blends comprising two or more of the polymers of this invention, or blends comprising at least one copolymer of this invention and at least one other polymer, may have a polydispersity greater than 4 although for spinning considerations, the polydispersity of such blends is still preferably between about 2 and about 4.

In one preferred embodiment of this invention, the propylene based elastomers or plastomers are further characterized as having at least one of the following properties: (i) ¹³C NMR peaks corresponding to a regio-error at about 14.6 and about 15.7 ppm, the peaks of about equal intensity, (ii) a DSC curve with a Tₘₑ that remains essentially the same and a Tₘₐₓ that decreases as the amount of comonomer, that is, the units derived from ethylene and/or the unsaturated comonomer(s), in the copolymer is increased, and (iii) an X-ray diffraction pattern when the sample is slow-cooled that reports more gamma-form crystals than a comparable copolymer prepared with a Ziegler-Natta (Z-N) catalyst. Typically the copolymers of this embodiment are characterized by at least two, preferably all three, of these properties. In other embodiments of this invention, these copolymers are characterized further as also having (iv) a skewness index, Sᵢₓ, greater than about −1.20. Each of these properties and their respective measurements are described in detail in U.S. Ser. No. 10/139,786 filed May 5, 2002 (WO02/003040442) as supplemented by WO2005/111282 which are incorporated herein by reference.

The fibers of the present invention also contain a slip additive in an amount sufficient to impart the desired haptics to the fiber. In the polypropylene based fiber applications of the present invention, it has been discovered that it is important to select right solubility or migration rate to avoid problems during fabrication or undesirable fiber properties such as oily feel, reduced bonding strength, etc. It has also been discovered that it is important to select the slip agent with proper molecular weight. A slip agent which is in solid form at room temperature (higher molecular weight) is generally preferred to one in liquid form, because the former will be more slowly released to the article's surface thereby providing a more durable slipping effect (see U.S. Pat. No. 5,969,026).

The slip agent is preferably a fast bloom slip agent, and can be a hydrocarbon having one or more functional groups selected from hydroxide, aryls and substituted aryls, halogens, alkoxys, carboxylates, esters, carbon unsaturation, acrylates, oxygen, nitrogen, carboxyl, sulfate and phosphate.

In one embodiment the slip agent is a salt derivative of an aromatic or aliphatic hydrocarbon oil, notably metal salts of fatty acids, including metal salts of carboxylic, sulfuric, and phosphoric aliphatic saturated or unsaturated acid having a chain length of 7 to 26 carbon atoms, preferably 10 to 22 carbon atoms. Examples of suitable fatty acids include the monocarboxylic acids lauric acid, stearic acid, succinic acid, stearyl lactic acid, lactic acid, phthalic acid, benzoic acid, hydroxystearic acid, ricinoleic acid, naphthenic acid, oleic acid, palmitic acid, erucic acid, and the like, and the corresponding sulfuric and phosphoric acids. Suitable metals include Li, Na, Mg, Ca, Sr, Ba, Zn, Cd, Al, Sn, Pb and so forth. Representative salts include, for example, magnesium stearate, calcium stearate, sodium stearate, zinc stearate, calcium oleate, zinc oleate, magnesium oleate and so on, and the corresponding metal higher alkyl sulfates and metal esters of higher alkyl phosphoric acids.

In one embodiment the slip agent is a non-ionic functionalized compound. Suitable functionalized compounds include: (a) esters, amides, alcohols and acids of oils including aromatic or aliphatic hydrocarbon oils, for example, mineral oils, naphthenic oils, paraffinic oils; natural oils such as castor, corn, cottonseed, olive, rapeseed, soybean, sunflower, other vegetable and animal oils, and so on. Representative functionalized derivatives of these oils include, for example, polyol esters of monocarboxylic acids such as glycerol monostearate, pentaerythritol monooleate, and the like, saturated and unsaturated fatty acid amides or ethylenebis(amides), such as oleamide, erucamide, linoleamide, and mixtures thereof, glycols, polyether polyols like Carbowax, and adipic acid, sebacic acid, and the like; (b) waxes, such as carnauba wax, microcrystalline wax, polyolefin waxes, for example polyethylene waxes; (c) fluoro-containing polymers such as polytetrafluoroethylene, fluorine oils, fluorine waxes and so forth; and (d) silicon compounds such as silanes and silicone polymers, including silicone oils, polydimethylsiloxane, amino-modified polydimethylsiloxane, and so on.

The fatty amides useful in the present invention are represented by the formula:

RC(O)NHR¹

where R is a saturated or unsaturated alkyl group having of from 7 to 26 carbon atoms, preferably 10 to 22 carbon atoms, and R¹ is independently hydrogen or a saturated or unsaturated alkyl group having from 7 to 26 carbon atoms, preferably 10 to 22 carbon atoms. Compounds according to this structure include for example, palmitamide, stearamide, arachidamide, behenamide, oleamide, erucamide, linoleamide, stearyl stearamide, palmityl palmitamide, stearyl arachidamide and mixtures thereof.

The ethylenebis(amides) useful in the present invention are represented by the formula:

RC(O)NHCH₂CH₂NHC(O)R

where each R is independently is a saturated or unsaturated alkyl group having of from 7 to 26 carbon atoms, preferably 10 to 22 carbon atoms. Compounds according to this structure include for example, stearamidoethylstearamide, stearamidoethylpalmitamide, palmitamidoethylstearamide, ethylenebisstearamide, ethylenebisoleamide, stearylerucamide, erucamidoethylerucamide, oleamidoethyloleamide, erucamidoethyloleamide, oleamidoethylerucamide, stearamidoethylerucamide, erucamidoethylpalmitamide, palmitamidoethyloleamide and mixtures thereof.

Commercially available examples of fatty amides include Ampacet 10061 which comprises 5 percent of a 50:50 mixture of the primary amides of erucic and stearic acids in polyethylene; Elvax 3170 which comprises a similar blend of the amides of erucic and stearic acids in a blend of 18 percent vinyl acetate resin and 82 percent polyethylene. These slip agents are available from DuPont. Slip agents also are available from Croda Universal, including Crodamide OR (an oleamide), Crodamide SR (a stearamide), Crodamide ER (an erucamide), and Crodamide BR (a behenamide); and from Crompton, including Kemamide S (a stearamide), Kemamide B (a behenamide), Kemamide O (an oleamide), Kemamide E (an erucamide), and Kemamide (an N,N′-ethylenebisstearamide). Other commercially available slip agents include Erucamid ER erucamide.

It has been discovered that for use with the polypropylene based fibers of the present invention, the preferred slip additives are fatty acid amides. Preferred fatty acid amides include stearamide, oleamide, and erucamide, with erucamide being most preferred for polypropylene systems.

As is generally known in the art, slip additives are conveniently added to a resin in the form of a pre-compound masterbatch. For the PP fibers of the present invention, low density polyethylene (“LDPE”), including LDPE wax (Mw<10000), is preferred as the carrier resin for making the master batch of the slip agent. This is because when used in small quantities, LDPE wax can be classified as an internal lubricant agent for polypropylene (“PP”) fibers (see WO 2004/005601). PP, especially PP waxes can also be used as a carrier resin, but they are more expensive.

In the fibers of the present invention, the slip additive preferably is present in an amount of from 100 to about 2500 ppm, preferably from at least 150 ppm to less than 2000 ppm, more preferably from 200 to 1500 ppm, and still more preferably from 250 ppm to less than 1000 ppm. In the preferred means of adding the slip additive (that is, as a precompound masterbatch), the slip agent can comprise from 0.1 to 50 percent by weight of the masterbatch, preferably from 1 to 10 weight percent of the masterbatch and most preferably from 5 to 10 percent of the masterbatch.

The fibers of the present invention are well suited for use in a spunbond nonwoven fabric. The nonwoven material of the present invention will preferably have a basis weight (weight per unit area) from 10 grams per square meter (gsm) to 300 gsm. In certain embodiments it is preferred that the nonwoven material have a basis weight of from 10 to 30 gsm. The basis weight can also be from 15 gsm to 60 gsm, and in one embodiment it can be about 20 gsm. Suitable base nonwoven webs can have an average filament denier of 0.10 to 10. Very low deniers can be achieved by the use of splittable fiber technology, for example. In general, reducing the filament denier tends to produce softer webs, and low denier microfibers from 0.10 to 2.0 denier can be utilized for even greater softness.

The degree of consolidation can be expressed as a percentage of the total surface area of the web that is consolidated. Consolidation can be substantially complete, as when an adhesive is uniformly coated on the surface of the nonwoven, or when bicomponent fibers are sufficiently heated so as to bond virtually every fiber to every adjacent fiber. Generally, however, consolidation is preferably partial, as in point bonding, such as thermal point bonding.

The discrete, spaced-apart bond sites formed by point bonding, such as thermal point bonding, only bond the fibers of the nonwoven in the area of localized energy input. Fibers or portions of fibers remote from the localized energy input remain substantially unbonded to adjacent fibers.

Similarly, with respect to ultrasonic or hydroentanglement methods, discrete, spaced apart bond sites can be formed to make a partially consolidated nonwoven web. The consolidation area, when consolidated by these methods, refers to the area per unit area occupied by the localized sites formed by bonding the fibers into point bonds (alternately referred to as “bond sites”), typically as a percentage of total unit area. A method of determining consolidation area is detailed below.

Consolidation area can be determined from scanning electron microscope (SEM) images with the aid of image analysis software. One or preferably more SEM images can be taken from different positions on a nonwoven web sample at 20× magnification. These images can be saved digitally and imported into Image-Pro PlusO software for analysis. The bonded areas can then be traced and the percent area for these areas be calculated based on the total area of the SEM image. The average of images can be taken as the consolidation area for the sample.

A web of the present invention preferably exhibits a percent consolidation area of less than about 25 percent, more preferably less than about 20 percent prior to mechanical post-treatment, if any.

The web of the present invention is characterized by high abrasion resistance and high softness, which properties are quantified by the web's tendency to fuzz and bending or flexural rigidity, respectively. Fuzz levels (or “fuzz/abrasion”) and flexural rigidity were determined according to the methods set out in the Test Methods section of WO02/31245, herein incorporated by reference in its entirety.

Fuzz levels, tensile strength and flexural rigidity are partly dependent on the basis weight of the nonwoven, as well as whether the fiber is made from a monocomponent or a bicomponent filament. For purposes of this invention a “monocomponent” fiber means a fiber in which the cross-section is relatively uniform. It should be understood that the cross section may comprise blends of more than one polymer but that it will not include “bicomponent” structures such as sheath-core, side-by-side islands in the sea, etc. In general heavier fabrics (that is fabrics at higher basis weight) will have higher fuzz levels, everything else being equal. Similarly heavier fabrics will tend to have higher values for tenacity and flexural rigidity and lower values for softness as determined according to the softness panel test as described in S. Woekner, “Softness and Touch—Important aspects of Non-wovens”, EDANA International Nonwovens Symposium, Rome Italy June (2003).

The nonwoven materials of the present invention preferably exhibit a fuzz/abrasion of less than about 0.5 mg/cm², more preferably less than about 0.3 mg/cm². It should be understood that the fuzz/abrasion will depend in part on the basis weight of the nonwoven as heavier fabrics will naturally produce more fuzz in the testing protocol.

In some embodiments of the present invention the polymer blend may optionally also contain an ethylene polymer for example, a high density polyethylene, low density polyethylene, linear low density polyethylene, and/or homogeneous ethylene/α-olefin plastomer or elastomer, preferably having a Melt Index of between 10 and 50 (as determined by ASTM D-1238, Condition 190° C./2.16 kg (formally known as “Condition (E)” and also known as I₂) and a density in the range of from 0.855 g/cc to 0.95 g/cc as determined by ASTM D-792 most preferably less than about 0.9. Suitable homogeneous ethylene/α-olefin plastomers or elastomers include linear and substantially linear ethylene polymers. The homogeneously branched interpolymer is preferably a homogeneously branched substantially linear ethylene/alpha-olefin interpolymer as described in U.S. Pat. No. 5,272,236. The homogeneously branched ethylene/alpha-olefin interpolymer can also be a linear ethylene/alpha-olefin interpolymer as described in U.S. Pat. No. 3,645,992 (Elston).

The substantially linear ethylene/alpha-olefin interpolymers discussed above are not “linear” polymers in the traditional sense of the term, as used to describe linear low density polyethylene (for example, Ziegler polymerized linear low density polyethylene (LLDPE)), nor are they highly branched polymers, as used to describe low density polyethylene (LDPE). Substantially linear ethylene/alpha-olefin interpolymers suitable for use in the present invention are herein defined as in U.S. Pat. No. 5,272,236 and in U.S. Pat. No. 5,278,272. Such substantially linear ethylene/alpha-olefin interpolymers typically are interpolymers of ethylene with at least one C₃-C₂₀ alpha-olefin and/or C₄-C₁₈ diolefins. Copolymers of ethylene and 1-octene are especially preferred.

Other additives such as antioxidants (for example, hindered phenols for example, Irganox® 1010 made by Ciba-Geigy Corp.), phosphites (for example, Irgafos® 168 made by Ciba-Geigy Corp.), cling additives (for example, polyisobutylene (PIB)), polymeric processing aids (such as Dynamar™ 5911 from Dyneon Corporation, and Silquest™ PA-1 from General Electric), antiblock additives, pigments, can also be included in the first polymer, the second polymer, or the overall polymer composition useful to make the fibers and fabrics of the invention, to the extent that they do not interfere with the enhanced fiber and fabric properties discovered by Applicants.

It is preferred that the first polymer (the isotactic polypropylene homopolymer or random copolymer) comprises from at least 50 more preferably 60 and most preferably at least about 70 percent up to about 95 percent by weight of the polymer blend. The second polymer (the propylene based elastomer or plastomer) comprises at least about 5 percent by weight of the blend, more preferably at least about 10 percent, up to about 50 percent, more preferably 40 percent, most preferably 30 percent by weight of the polymer blend. The optional third polymer (the homogeneous ethylene/α-olefin plastomer or elastomer), if present, can comprise up to about 10 percent, more preferably up to about 5 percent by weight of the polymer blend.

The compositions disclosed herein can be formed by any convenient method, including dry blending the individual components and subsequently melt mixing or by pre-melt mixing in a separate extruder (for example, a Banbury mixer, a Haake mixer, a Brabender internal mixer, or a twin screw extruder), or in a dual reactor.

Another technique for making the compositions in-situ is disclosed in U.S. Pat. No. 5,844,045, the disclosure of which is incorporated herein in its entirety by reference. This reference describes, inter alia, interpolymerizations of ethylene and C₃-C₂₀ alpha-olefins using a homogeneous catalyst in at least one reactor and a heterogeneous catalyst in at least one other reactor. The reactors can be operated sequentially or in parallel.

The nonwoven fabrics of present invention may include monocomponent and/or bicomponent fibers. “Bicomponent fiber” means a fiber that has two or more distinct polymer regions or domains. Bicomponent fibers are also known as conjugated or multicomponent fibers. The polymers are usually different from each other although two or more components may comprise the same polymer. The polymers are arranged in substantially distinct zones across the cross-section of the bicomponent fiber, and usually extend continuously along the length of the bicomponent fiber. The configuration of a bicomponent fiber can be, for example, a sheath/core arrangement (in which one polymer is surrounded by another), a side by side arrangement, a pie arrangement or an “islands-in-the sea” arrangement. Bicomponent fibers are further described in U.S. Pat. Nos. 6,225,243, 6,140,442, 5,382,400, 5,336,552 and 5,108,820.

In sheath-core bicomponent fibers, it is preferred that the polymer blends of the present invention comprise the core. The sheath may advantageously be comprised of polyethylene homopolymers and/or copolymers, including linear low density polyethylene and substantially linear low density polyethylene.

It should be understood that the nonwoven fabric of the present invention can comprise of either continuous or noncontinuous fibers (such as staple fibers). Furthermore, it should be understood that in addition to the nonwoven materials described above, the fibers can be used in any other fiber application known in the art, such as binder fibers, and carpet fibers. For sheath-core fibers for use in binder fibers, the polymer blends of the present invention may advantageously comprise the sheath with the core being a polyethylene (including high density polyethylene and linear low density polyethylene), polypropylene (including homopolymer or random copolymer (preferably with no more than about 3 percent ethylene by weight of the random copolymer) or polyesters such as polyethylene terephthalate.

In another aspect of the invention, a method of improving the softness of a spunbond nonwoven fabric is provided. The method comprises A) selecting a polymer comprising i) from 50 to 90 percent (by weight of the fiber) of a first polymer which is an isotactic polypropylene homopolymer or random copolymer having a melt flow rate in the range of from 10 to 70 grams/10 minutes, and ii) from 10 to 50 percent (by weight of the fiber) of a second polymer which is a reactor grade propylene based elastomer or plastomer having a heat of fusion less than about 70 joules/gm, said propylene based elastomer or plastomer having a melt flow rate of from 2 to 1000 grams/10 minutes, B) adding a sufficient amount of slip agent to impart desired softness attributes to the fiber; and C) forming a spun bond melt blown fabric from the polymer in A with the slip agent in B.

Another aspect of the present invention is the use of slip agent to improve the softness of propylene based spunbond nonwoven fabrics. The preferred slip agent for this use is erucamide, and it preferably comprises from 100 ppm to 2500 ppm, preferably from at least 150 ppm to less than 2000 ppm, more preferably from 200 to 1500 ppm, and still more preferably from 250 ppm to less than 1000 ppm by weight of the nonwoven.

### EXAMPLES

### Testing Methods

Bending Stiffness:

Specimens for bending stiffness were obtained by cutting 1 inch wide by 6 inch long strips from the center of the fabric with the long axis of the strip aligned parallel to the machine direction (MD) of the fabric. MD is defined as the direction of the fabric that was parallel to the movement of the collector or belt movement during fabric formation. Basis weight in g/m², was determined for each sample by dividing the weight of the sample, measured with an analytical balance (Model AE200, Mettler-Toledo, Columbus, Ohio), by the area (6 in²). The bending stiffness (G) of the fabric samples was measured according to ASTM D 5732-95. G was calculated using equation 1.

G=9.8 m×C³10⁻³(mN cm) (1)

where G is the mean flexural rigidity per unit width in millinewton centimeters, m is basis weight of the sample measured in g/m², and C is the bending length, in cm, of the test piece. The indicator was inclined at an angle of 41.50 with the horizontal for all measurements.

Tensile Testing of Nonwoven Fabrics:

Specimens for nonwoven measurements were obtained by cutting 1 inch wide by 6 long inch strips from the center of the web in the machine (MD) as described earlier for bending stiffness. Basis weight, in g/m² was determined for each sample as described earlier for bending stiffness. Samples were then loaded with MD parallel to crosshead displacement into an Instron 5564 fitted with a 100 N load cell (calibrated and balanced) and pneumatically activated line-contact grips (flat grip facing was coated with rubber) with an initial separation of 2 inches. This was accomplished by first inserting the sample into the top grip and engaging the top grip to clamp about 1 inch from the narrow edge of the sample. The bottom of the samples was allowed to dangle and hang between the gripping surfaces of the bottom grip. A 3.2 gram clip was attached to the bottom of the sample such that the sample was held taught by the weight of the grip and the clip hung below the gripping surfaces of the lower grip. Care was taken to make sure that the clip did not come into contact with any part of the lower grip. The lower grip was then engaged to clamp only the nonwoven sample. Pressure on the engaged grip was kept sufficient to prevent slippage (usually 50-100 psi). Samples were then pulled to break at a crosshead speed of 10 inches/min. The load and extension were recorded every 0.254 mm of crosshead displacement (0.5 percent strain increments).

Strain was calculated by dividing the crosshead displacement by 2 inches and multiplying by 100. Reduced load (gf/gsm/1 inch width) was calculated by dividing the force measured in grams (gf) by the basis weight of the 1 inch wide sample described above. Elongation at break was defined according to equation 2:

$$Elongation ( \% ) = \frac{{L}_{break} - {L}_{o}}{{L}_{o}} \times 100 \% \qquad ( 2 )$$

where Lₒ is the initial length of 2 inches, and L_{break} is the length at break. Tensile strength was defined as the reduced load at break. This usually corresponded to maximum reduced load. Sometimes maximum reduced load did not correspond to elongation at break. Usually, this corresponded to partial rupture of the sample. In this case, the maximum reduced load was taken as the tensile strength and its corresponding elongation was taken as the elongation at break.

Abrasion Resistance

A nonwoven fabric or laminate was abraded using a Sutherland 2000 Rub Tester to determine the fuzz level. A lower fuzz level is desired which means the fabric has a higher abrasion resistance. An 11.0 cm×4.0 cm piece of nonwoven fabric was abraded with sandpaper, which resulted in loose fibers accumulating on the top of the fabric. The loose fibers were collected using tape and measured gravimetrically. The fuzz level is then determined as the total weight of loose fiber in grams divided by the fabric specimen surface area (44.0 cm²)

COF Measurement

The COF test for fabrics was adopted from a modified COF measurement for films. It was conducted on COF Tester Model 32-06 made by Test Machine, Inc. The fabric specimen in 2″×2″ square was adhered to a metal platform by using a double sided adhesion tape. A surface contact between a metal to fabric was used instead of fabric to fabric contact. The test conditions were defined as follows: the load was 200 grams, the moving speed was 6″/min. The equipment records an average Kinetic COF for the last 5 inches, which is taken as the COF of the fabric sample. The mean values of COF and standard deviation were determined by averaging the results from five specimens per each sample.

Handfeel Perception Measurement

The concept fabrics were tested by haptics panel according to the BBA softness panel test as described in S. Woekner, “Softness and Touch—Important aspects of Non-wovens”, edana International Nonwovens Symposium, Rome Italy June (2003). Attributes relating to surface characteristics were tested on a stack of tissue papers covered with a layer of fabrics. Pliable-stiffness was perceived on a single piece of fabrics.

The panelists are allowed touch but not see the samples. They are asked to rank the samples 1 to 4, where 4 is the total number of samples, and 1 represented the least favorable perception and 4 represented the most favorable perception. No tie is permitted. Three attributes were determined as being the most important parameters in hand feel perception: Cottony, Smoothness and Pliable (Softness). These attributes are described in Table 1. A minimum of 20 panelists are required to obtain a statistically meaningful comparison. The data of average and standard variations were analyzed by using the ANOVA (Analysis of Variance) technology, and the comparison of significance of statistical differences among the samples were by using the Tukey-Kramer method with alpha being set at 5 percent. The actual analysis of the handfeel perception data was conducted by using JMP™ statistical software.

TABLE 1
Descriptions of Attributes for Handfeel Perception Test

| Attributes | Description |
|---|---|
| Cottony | The perception of what a cotton fabric should feel like. |
| | Cottony → Non-Cottony |
| Smoothness | The amount of abrasive particles in the surface of |
| | the sample. |
| | Rough → Smooth |
| Pliable- | The perception of what a pliable fabric should feel like. |
| Softness | Stiff → Pliable |

Fabrication of Spun Bond Fabrics

A trial was conducted using Reicofil 3 Spunbond technology. For this line, two extruders were running into a spinnerette block (bico-fiber configuration). The two extruders had different outputs and also went through two spin pumps with different outputs. However for these trials the output of each spinpump was equal and a total output of between 0.5 ghm to 0.67 ghm was achieved producing fabrics at 20 gsm with a linespeed of between 100 n/min to 150 n/min with fibers having 2 to 3 dpf. For this trial the embossed calendar roll and smooth roll were the same oil temperature.

Resins used during the trial are listed below:

Resin A is homopolymer polypropylene, 25 MFR

Resin B is propylene based elastomer, 12 wt percent ethylene, 25 MFR

Ampacet 10090—slip agent masterbatch, 5 percent Erucamide in LDPE

Example 1 was: 68.5 (percent by weight) Resin A/30 percent Resin B/1.5 percent Ampacet 10090 (LDPE as the polymer carrier of the masterbatch, equivalent to 750 ppm erucamide).

Three comparative resins or resin blends are also prepared:

Example 2 (comparative) 98.5 percent Resin A/1.5 percent Ampacet 10090

Example 3 (comparative) 70 percent Resin A/30 percent Resin B

Example 4 (comparative) 100 percent Resin A

Bonding curves were generated based on a Calender roll temperature of from 125° C. to 155° C. and a Calender roll pressure of from 50 to 70 N/mm as reported in Table 2. The spun bond (“SB”) fabric samples are listed in Table 2.

TABLE 2
Fabric samples

| | Calender | | Tensile | Elongation | Bending | | |
|---|---|---|---|---|---|---|---|
| | roll | Calender | strength | at Break | Stiffness* | Abrasion | |
| EXAMPLE | temperature | roll pressure | MD/CD | MD/CD | MD | Resistance | Coefficient |
| # | (° C.) | (N/mm) | (g/gsm-in.) | (Percent) | (Nm · cm) | (mg/cm²) | of Friction |
| 1-1 | 125 | 70 | 73.6/45.6 | 62.0/73.1 | 0.109 | NM | NM |
| 1-2 | 130 | 70 | 80.4/41.0 | 61.1/70.4 | 0.077 | NM | NM |
| 1-3 | 135 | 70 | 72.4/60.7 | 57.3/65.7 | 0.110 | 0.533 | 0.36 |
| 1-4 | 140 | 70 | 79.0/56.5 | 63.8/74.4 | 0.126 | 0.429 | 0.30 |
| 1-5 | 145 | 70 | 71.6/52.5 | 48.2/59.2 | 0.084 | NM | NM |
| 1-6 | 150 | 70 | 76.1/51.6 | 50.3/58.3 | 0.180 | NM | NM |
| 1-7 | 155 | 70 | 58.0/38.6 | 39.2/40.9 | 0.210 | NM | NM |
| 1-8 | 125 | 50 | 78.2/50.7 | 72.7/74.9 | 0.092 | NM | NM |
| 1-9 | 130 | 50 | 71.5/46.3 | 66.4/69.1 | 0.109 | NM | NM |
| 1-10 | 135 | 50 | 81.7/56.2 | 63.6/76.5 | 0.116 | 0.446 | 0.22 |
| 1-11 | 140 | 50 | 81.3/57.6 | 64.4/81.8 | 0.124 | 0.395 | 0.27 |
| 1-12 | 145 | 50 | 67.3/49.2 | 54.1/67.1 | 0.163 | NM | NM |
| 1-13 | 150 | 50 | 69.0/44.6 | 45.9/54.7 | 0.148 | NM | NM |
| 1-14 | 155 | 50 | 54.5/31.1 | 31.8/37.1 | 0.145 | NM | NM |
| 2-1 | 135 | 70 | 50.4/32.3 | 16.9/21.9 | 0.348 | 0.871 | 0.18 |
| 2-2 | 140 | 70 | 78.6/49.6 | 30.1/36.5 | 0.338 | 0.827 | 0.22 |
| 2-3 | 145 | 70 | 114.5/50.9 | 52.8/40.3 | 0.397 | 0.746 | NM |
| 2-4 | 150 | 70 | 116.6/66.0 | 52.8/57.3 | 0.372 | NM | NM |
| 2-5 | 155 | 70 | 122.2/74.0 | 60.3/57.4 | 0.459 | NM | NM |
| 2-6 | 135 | 50 | 53.5/20.0 | 20.6/20.6 | 0.450 | 1.042 | 0.19 |
| 2-7 | 140 | 50 | 69.3/27.4 | 35.3/31.3 | 0.595 | 0.862 | 0.19 |
| 2-8 | 145 | 50 | 104.6/52.9 | 64.5/55.4 | 0.439 | 0.784 | NM |
| 2-9 | 150 | 50 | 113.0/58.4 | 69.1/57.4 | 0.638 | NM | NM |
| 2-10 | 155 | 50 | 116.8/63.8 | 71.3/73.8 | 0.707 | NM | NM |
| 3-1 | 125 | 70 | 70.7/48.0 | 67.1/75.0 | 0.185 | NM | NM |
| 3-2 | 135 | 70 | NM | NM | NM | NM | 0.59 |
| 3-3 | 140 | 70 | 68.1/49.1 | 58.7/75.7 | 0.142 | 0.414 | NM |
| 4-1 | 145 | 70 | 95.7/46.9 | 46.2/38.4 | 0.673 | 0.838 | 0.29 |

NM = not measured
*Equation 1 was approximated as G = 10m × C³10⁻³

Temperature reported in table is oil temperature. The temperature for the rolls is approximately 7° C. lower for the particular equipment used.

### DISCUSSION OF RESULTS

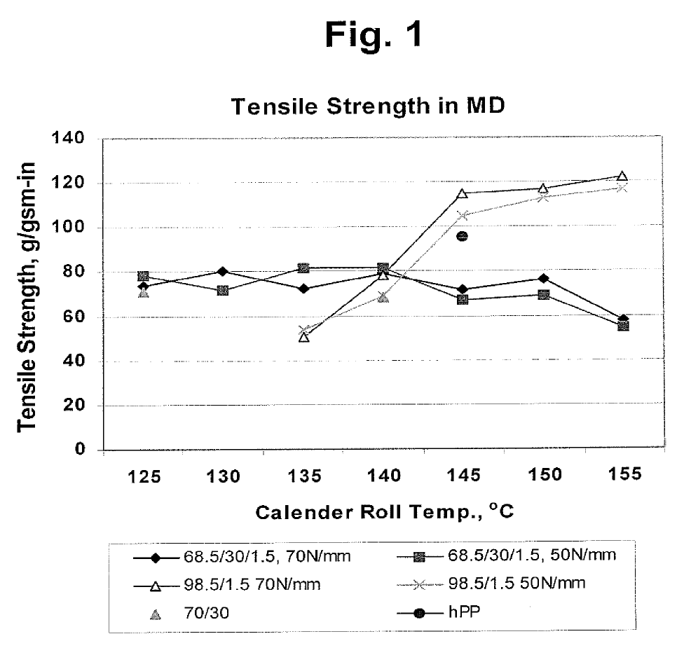

FIG. 1 displays the tensile strength (break load) of the fabric samples in Table 2. It is demonstrated that the new formulation had a very broad bonding window in MD. In comparison, the hPP samples did not demonstrate good web formation below about 145 degrees.

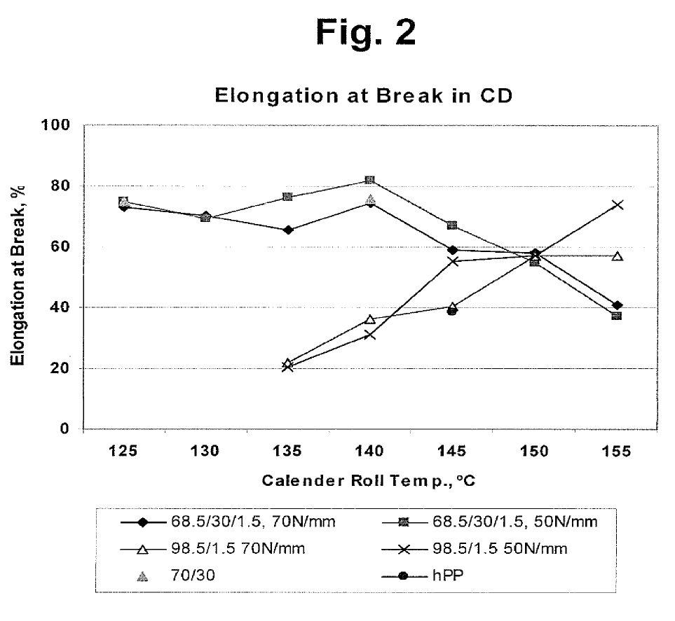

FIG. 2 demonstrates that the new formulation displays good elongation at break in CD for calendar roll temperatures up to 140° C. It also demonstrates that the new formulation (50N/mm) shows improved elongation at break in CD compared to hPP, 70/30 blend, and hPP with erucamide. In general, a lower calendar roll pressure (50 vs. 70 N/mm) positively affected elongation at break.

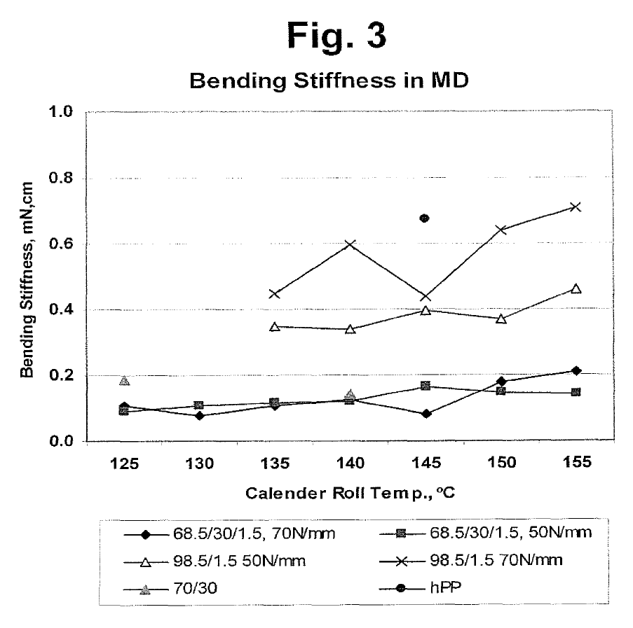

FIG. 3 demonstrates that the new formulation has much lower bending stiffness compared to hPP and hPP/erucamide spun bond fabrics. It should also be noted that in general, a higher oil temperature makes stiffer spun bond fabrics, as expected. While a high roll pressure makes much stiffer fabrics for hPP with erucamide, unexpectedly, the roll pressure had no impact on the new formulation.

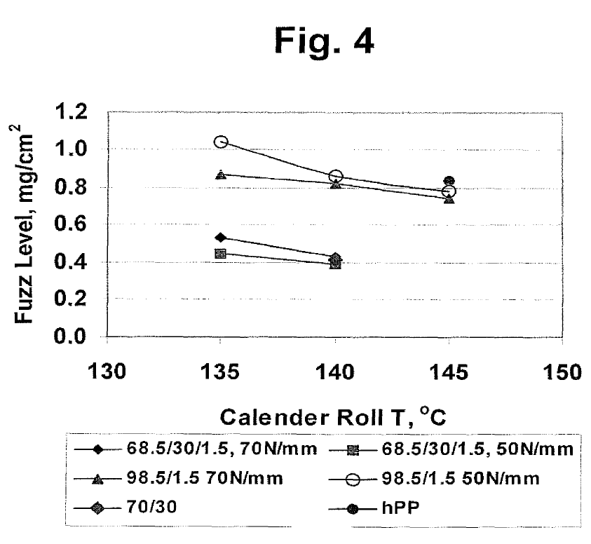

In FIG. 4, the new formulation shows excellent abrasion resistance, similar to 70/30 hPP/DE4300 blend, much improved compared to hPP with erucamide only. The new formulation shows even better abrasion resistance at a lower roll pressure (50 vs. 70 N/mm), which is unexpected. This indicates a very broader bonding window in roll temperatures and pressures for this new formulation.

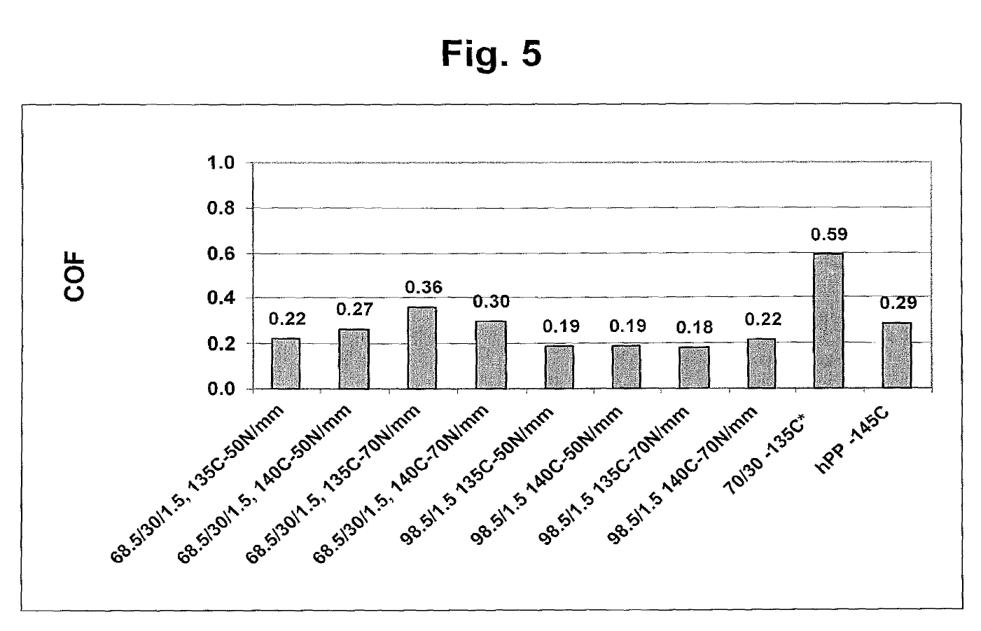

FIG. 5 shows the comparison of fabric COF results. It is seen that new formulation shows improvement in COF vs. 70/30 hPP/PBE blend.

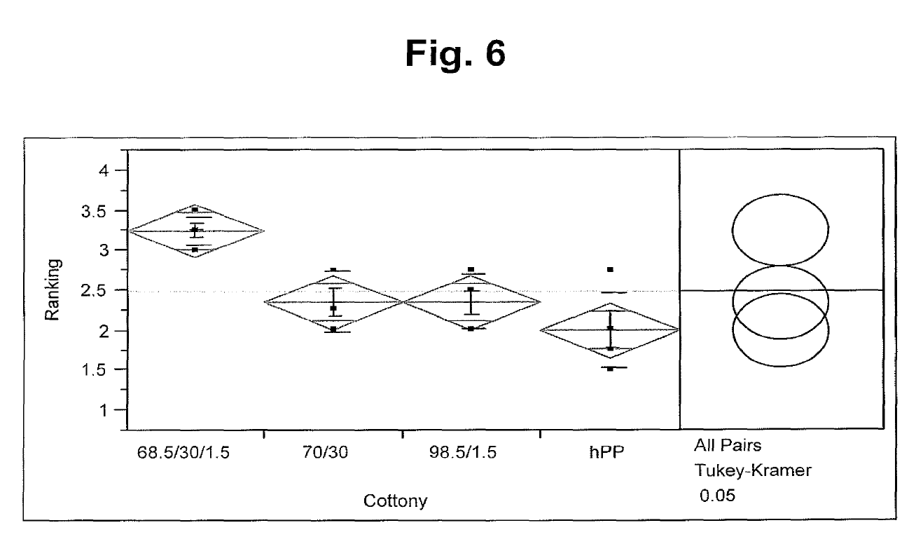

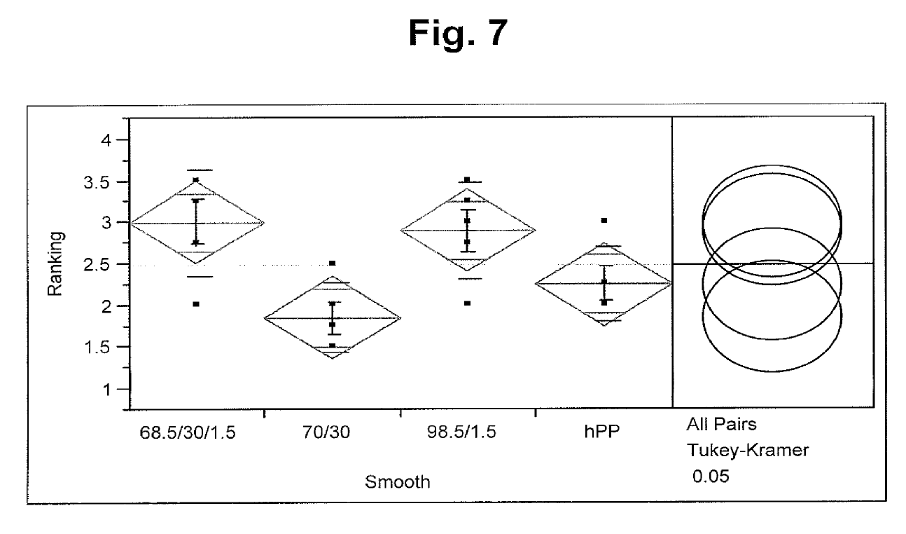

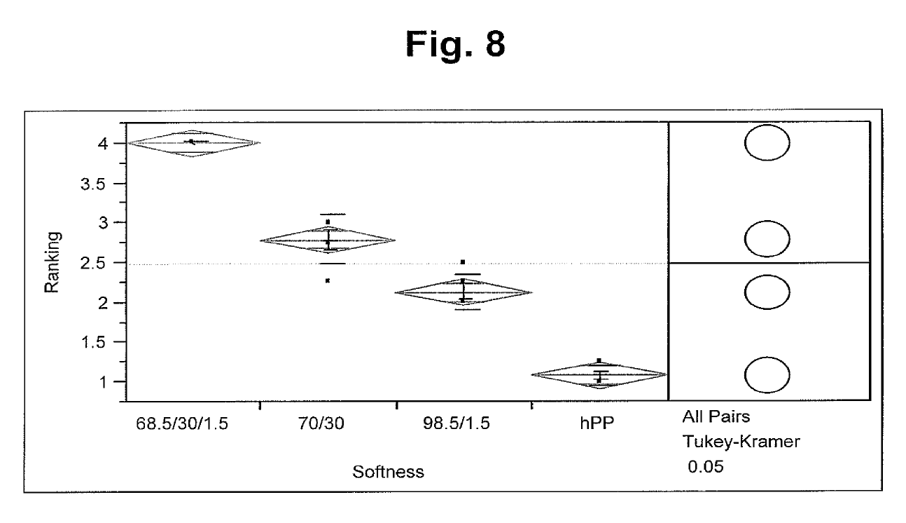

The handfeel perception test was carried out using a ranking method. Attributes relating to surface characteristics (cottony and smoothness) were tested on a stack of tissue papers covered with a layer of fabrics. Softness (pliable) was perceived on a single piece of each of the fabrics. Twenty to twenty-four panelists participated the test. The results are shown in Table 3 and FIGS. 6, 7 and 8 for cottony, smoothness and softness, respectively. While a higher ranking number represents a preferred feeling, it is seen that the new formulation perceived as the best fabric in all three attributes, especially in the attribute of “softness (pliable)”.

TABLE 3
Handfeel Perception Results

| | | Bond Roll | Calender Roll | Cotton | Smooth | Softness |
|---|---|---|---|---|---|---|
| | Samples Evaluated | Temperature, C. | Pressure, N/mm | Ranking | Ranking | Ranking |
| 1 | 200401113-28-4 (68.5/30/1.5 | 140 | 70 | 3.30 | 3.00 | 4.00 |
| | hPP/DE4300/Erucamide MB) | | | | | |
| 2 | 200401113-28-16 (98.5/1.5 | 140 | 70 | 2.35 | 2.90 | 2.13 |
| | hPP/Erucamide MB) | | | | | |
| 3 | 200401113-29-26 (70/30 | 140 | 70 | 2.35 | 1.85 | 2.79 |
| | hPP/DE4300) | | | | | |
| 4 | 200401113-29-29 (hPP) | 145 | 70 | 2.00 | 2.25 | 1.08 |

What is claimed is:

1. A spun bond nonwoven fabric made using fibers having a diameter in a range of from 0.1 to 50 denier and wherein the fibers comprise:
a. from 50 to 90 percent (by weight of the fiber) of a first polymer which is an isotactic polypropylene homopolymer or random copolymer, and
b. from 10 to 50 percent (by weight of the fiber) of a second polymer which is a reactor grade propylene based elastomer or plastomer having a heat of fusion less than about 70 joules/gm, said propylene based elastomer or plastomer, and
c. from 100 to 2500 ppm (by weight of the fiber) of a slip agent.

2. The spun bond nonwoven fabric of claim 1 wherein the fibers comprise from 150 ppm to less than 2000 ppm of a slip agent.

3. The spun bond nonwoven fabric of claim 1 wherein the fibers comprise from 200 to 1500 ppm of a slip agent.

4. The spun bond nonwoven fabric of claim 1 wherein the fibers comprise from 250 ppm to less than 1000 ppm of a slip agent.

5. The spun bond nonwoven fabric of claim 1 where the slip agent is a fatty acid amide

6. The spun bond nonwoven fabric of claim 5 where the fatty acid amide is erucamide.

7. The spun bond nonwoven fabric of claim 1 wherein the first polymer is selected from the group consisting of homopolymer polypropylene and random copolymers of propylene and one or more alpha-olefins.

8. The spun bond nonwoven fabric of claim 7 wherein the first polymer is a random copolymer of propylene and ethylene and the units derived from ethylene represent no more than about 3 percent by weight of the first polymer.

9. The spun bond nonwoven fabric of claim 1 wherein the second polymer is derived from ethylene comonomer and contains 3 to 15 weight percent ethylene comonomer.

10. The spun bond nonwoven fabric of claim 9 wherein the second polymer is derived from ethylene comonomer and contains 5 to 13 weight percent ethylene comonomer.

11. The spun bond nonwoven fabric of claim 10 wherein the second polymer contains 9 to 12 percent by weight of the second polymer of units derived from ethylene.

12. The spun bond nonwoven fabric of claim 1 wherein the second polymer has a melt flow rate of from 2 to 1000 grams/10 minutes.

13. The spun bond fabric of claim 12 wherein the second polymer has a melt flow rate of from 10 to 70 grams/10 minutes.

14. The spun bond nonwoven fabric of claim 13 wherein the second polymer has a melt flow rate of from 20 to 40 grams/10 minutes

15. The spun bond nonwoven fabric of claim 1 wherein the second polymer has a heat of fusion of less than about 70 joules/gm, but more than about 10 joules/gm.

16. The spun bond nonwoven fabric of claims 1 wherein the second polymer comprises 10 to 25 percent of the polymer blend.

17. The spun bond nonwoven fabric of claim 1 wherein the first polymer has a melt flow rate of from 10 to 70 grams/10 minutes.

18. The spun bond nonwoven fabric of claim 1 wherein the fibers further comprise a third polymer at less than 10 wt percent of the fiber, which third polymer is selected from the group consisting of high density polyethylene, linear low density polyethylene or homogeneously branched linear or substantially linear polyethylene.

19. The spun bond nonwoven fabric of claim 18 wherein the third polymer comprises 0.01 to 5 percent by weight of the polymer blend.

20. The spun bond fabric of claim 1 wherein the fabric has a basis weight from 10 grams per square meter (gsm) to 30 gsm.

21. A method of improving the softness of spunbond nonwoven fabrics made by extruding polymeric materials to form fibers in the spun bond process, wherein the polymeric materials comprise propylene based resins, the method comprising adding from 100 to 2500 ppm by weight of the polymeric materials of a slip agent to the polymeric materials prior to extruding the polymeric materials.

22. The method of claim 21 wherein the slip agent is a fatty acid amide.

23. The method of claim 21 wherein the slip additive is added in an amount of from 250 ppm to less than 1000 ppm.

24. The method of claim 21 wherein the polymeric material comprises:
a. from 50 to 90 percent (by weight of the fiber) of a first polymer which is an isotactic polypropylene homopolymer or random copolymer having a melt flow rate in the range of from 10 to 70 grams/10 minutes, and
b. from 10 to 50 percent (by weight of the fiber) of a second polymer which is a reactor grade propylene based elastomer or plastomer having a heat of fusion less than about 70 joules/gm, said propylene based elastomer or plastomer having a melt flow rate of from 2 to 1000 grams/10 minutes.
